(19) United States
(12) Patent Application Publication
(10) Pub. No.: US 2026/0189397 A1
(43) Pub. Date: Jul. 2, 2026

(54) SYSTEMS AND METHODS FOR SECURELY MANAGING AND PROCESSING SEGMENTED DATA

(71) Applicant: Sysnet North America, Inc., Chicago, IL (US)

(72) Inventors: Thomas Joseph Patterson, Sumter, SC (US); James Kevin Pierce, Raleigh, NC (US)

(73) Assignee: Sysnet North America, Inc., Chicago, IL (US)

(21) Appl. No.: 19/436,451

(22) Filed: Dec. 30, 2025

Related U.S. Application Data
(60) Provisional application No. 63/739,944, filed on Dec. 30, 2024.

(51) Int. Cl. H04L 9/32

(52) U.S. Cl. CPC H04L 9/3239; H04L 9/3218

(57) ABSTRACT

Systems, methods, and computer program products are provided for securely managing and processing segmented data. An example method includes receiving at least one first entity identifier data packet associated with a first entity. The at least one first entity identifier data packet comprises a plurality of first entity identification values. The example method also includes generating a first entity Merkle root based on each of the plurality of first entity identification values. The example method further includes generating a first entity encryption associated with the first entity. The first entity Merkle root is used as a public identifier for the first entity encryption. The example method still further includes determining the first entity associated with the first entity encryption based on the public identifier.

### CROSS-REFERENCE TO RELATED APPLICATIONS

The present application claims priority to U.S. Patent Application No. 63/739,944, entitled “SYSTEMS AND METHODS FOR SECURELY MANAGING AND PROCESSING SEGMENTED DATA”, filed on Dec. 30, 2024; the entirety of the application is incorporated herein by reference.

### FIELD

An example embodiment relates generally to systems and methods for processing and securing data, and more particularly, to securely managing and processing segmented data.

### BACKGROUND

There are increasing difficulties in managing and securing data as the amount of data increases. As the digital world increases, the ability to effectively process and/or use data without creating security weaknesses is greatly reduced. As such, currently there is a limitation to the size and scale of data that can be used securely. Therefore, there exists a need for a system that allows for efficient management without creating security concerns.

### SUMMARY

The following paragraphs present a summary of various embodiments of the present disclosure and are merely examples of potential embodiments. As such, the summary is not meant to limit the subject matter or variations of various embodiments discussed herein.

In some aspects, the techniques described herein relate to a system for identifying entities associated with encrypted values, the system including: at least one non-transitory storage device; and at least one processing device coupled to the at least one non-transitory storage device, wherein the at least one processing device is configured to: receive at least one first entity identifier data packet associated with a first entity, wherein the at least one first entity identifier data packet includes a plurality of first entity identification values; generate a first entity Merkle root based on each of the plurality of first entity identification values; generate a first entity encryption associated with the first entity, wherein the first entity Merkle root is used as a public identifier for the first entity encryption; and determine the first entity associated with the first entity encryption based on the public identifier.

In some aspects, the techniques described herein relate to a system, wherein the first entity encryption uses a Feige-Fiat-Shamir (FFS) identification scheme.

In some aspects, the techniques described herein relate to a system, wherein the at least one processing device is further configured to convert the first entity Merkle root from a hex to a decimal for use as the public identifier.

In some aspects, the techniques described herein relate to a system, wherein the first entity Merkle root is generated via a first hash of a first entity identification value and a second entity identification value of the plurality of first entity identification values and a second hash of a third entity identification value and a fourth entity identification value of the plurality of first entity identification values.

In some aspects, the techniques described herein relate to a system, wherein the first entity Merkle root is generated via a hash using the first hash and the second hash as inputs.

In some aspects, the techniques described herein relate to a system, wherein the plurality of first entity identification values includes at least one of an entity name, an entity address, an entity domain, an entity phone number, a provisioned product, or a contact name.

In some aspects, the techniques described herein relate to a system, wherein the first entity Merkle root is generated using SHA-256 hash functionality.

In some aspects, the techniques described herein relate to a system, wherein a first entity PIN is used as a secret value for the first entity encryption.

In some aspects, the techniques described herein relate to a system, wherein the first entity associated with the first entity encryption is determined from the first entity encryption in an instance in which the first entity encryption is encrypted.

In some aspects, the techniques described herein relate to a system, wherein the first entity encryption is one of at least one encryptions, wherein the at least one processing device is further configured to determine a plurality of entities associated with one or more encryptions based on the public identifier for a given encryption.

In some aspects, the techniques described herein relate to a method for identifying entities associated with encrypted values, the method including: receiving at least one first entity identifier data packet associated with a first entity, wherein the at least one first entity identifier data packet includes a plurality of first entity identification values; generating a first entity Merkle root based on each of the plurality of first entity identification values; generating a first entity encryption associated with the first entity, wherein the first entity Merkle root is used as a public identifier for the first entity encryption; and determining the first entity associated with the first entity encryption based on the public identifier.

In some aspects, the techniques described herein relate to a method, wherein the first entity encryption uses a Feige-Fiat-Shamir (FFS) identification scheme.

In some aspects, the techniques described herein relate to a method, further including converting the first entity Merkle root from a hex to a decimal for use as the public identifier.

In some aspects, the techniques described herein relate to a method, wherein the first entity Merkle root is generated via a first hash of a first entity identification value and a second entity identification value of the plurality of first entity identification values and a second hash of a third entity identification value and a fourth entity identification value of the plurality of first entity identification values.

In some aspects, the techniques described herein relate to a method, wherein the first entity Merkle root is generated via a hash using the first hash and the second hash as inputs.

In some aspects, the techniques described herein relate to a method, wherein the plurality of first entity identification values includes at least one of an entity name, an entity address, an entity domain, an entity phone number, a provisioned product, or a contact name.

In some aspects, the techniques described herein relate to a method, wherein the first entity Merkle root is generated using SHA-256 hash functionality.

In some aspects, the techniques described herein relate to a method, wherein a first entity PIN is used as a secret value for the first entity encryption.

In some aspects, the techniques described herein relate to a method, wherein the first entity associated with the first entity encryption is determined from the first entity encryption in an instance in which the first entity encryption is encrypted.

In some aspects, the techniques described herein relate to a method, wherein the first entity encryption is one of at least one encryptions, wherein the method further includes determining a plurality of entities associated with one or more encryptions based on the public identifier for a given encryption.

In some aspects, the techniques described herein relate to a computer program product for identifying entities associated with encrypted values, the computer program product including at least one non-transitory computer-readable medium having one or more computer-readable program code portions embodied therein, the one or more computer-readable program code portions including at least one executable portion configured to: receive at least one first entity identifier data packet associated with a first entity, wherein the at least one first entity identifier data packet includes a plurality of first entity identification values; generate a first entity Merkle root based on each of the plurality of first entity identification values; generate a first entity encryption associated with the first entity, wherein the first entity Merkle root is used as a public identifier for the first entity encryption; and determine the first entity associated with the first entity encryption based on the public identifier.

In some aspects, the techniques described herein relate to a computer program product, wherein the first entity encryption uses a Feige-Fiat-Shamir (FFS) identification scheme.

In some aspects, the techniques described herein relate to a computer program product, wherein the one or more computer-readable program code portions include at least one executable portion further configured to convert the first entity Merkle root from a hex to a decimal for use as the public identifier.

In some aspects, the techniques described herein relate to a computer program product, wherein the first entity Merkle root is generated via a first hash of a first entity identification value and a second entity identification value of the plurality of first entity identification values and a second hash of a third entity identification value and a fourth entity identification value of the plurality of first entity identification values.

In some aspects, the techniques described herein relate to a computer program product, wherein the first entity Merkle root is generated via a hash using the first hash and the second hash as inputs.

In some aspects, the techniques described herein relate to a computer program product, wherein the plurality of first entity identification values includes at least one of an entity name, an entity address, an entity domain, an entity phone number, a provisioned product, or a contact name.

In some aspects, the techniques described herein relate to a computer program product, wherein the first entity Merkle root is generated using SHA-256 hash functionality.

In some aspects, the techniques described herein relate to a computer program product, wherein a first entity PIN is used as a secret value for the first entity encryption.

In some aspects, the techniques described herein relate to a computer program product, wherein the first entity associated with the first entity encryption is determined from the first entity encryption in an instance in which the first entity encryption is encrypted.

In some aspects, the techniques described herein relate to a computer program product, wherein the first entity encryption is one of at least one encryptions, wherein the one or more computer-readable program code portions include at least one executable portion further configured to determine a plurality of entities associated with one or more encryptions based on the public identifier for a given encryption.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. Therefore, in the drawings:

FIG. 1 provides a block diagram illustrating a system environment for securely managing and processing segmented data, in accordance with various embodiments of the present disclosure;

FIG. 2 provides a block diagram illustrating the data management server(s) 151 of FIG. 1, in accordance with various embodiments of the present disclosure;

FIG. 3 provides a block diagram illustrating the computing device(s) 152 of FIG. 1, in accordance with various embodiments of the present disclosure;

FIG. 4 is a flow chart that details a method of securely managing and processing segmented data, in accordance with various embodiments of the present disclosure;

FIG. 5 illustrates an example Merkle tree, in accordance with various embodiments of the present disclosure; and

FIG. 6 illustrates example code used to generate an encryption associated with an entity, in accordance with various embodiments of the present disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements.

Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises”, and “comprising” are used in a non-exclusive sense, except where the context requires otherwise. Likewise, the term “includes” and its grammatical variants are intended to be non-limiting, such that recitation of items in a list is not to the exclusion of other like items that can be substituted or added to the listed items.

### I. Example Use Case

As the amount of data relating to different entities increases, the ability to efficiently identify, process, manage, and/or otherwise interact with the data is reduced. Additionally, the ability to secure the data, especially with stringent data privacy regulations, is paramount. However, using data and securing data are often counter to one another, as some systems that may be more user-friendly often present security concerns and more secure systems often are difficult to efficiently use. Existing solutions often fail to balance efficiency, scalability, and privacy, especially in high-volume environments.

The challenges in rapidly growing digital environments include managing large-scale customer data, meeting data privacy requirements, and maintaining the efficiency of customer identification processes. One important point of data processing that is often hampered due to security procedures is the identification of data (e.g., identifying the data associated with a given entity). Traditional identification systems struggle to provide secure, rapid, and compliant access to customer account information without exposing private data, leading to potential privacy and security risks.

Various embodiments of the present disclosure provide for securely managing and processing segmented data. To do this, various embodiments of the present disclosure provide a system for secure and efficient identification of data associated with specific entities (e.g., customers and organizations) in a digital ecosystem. By combining Merkle Trees and cryptography schemes (e.g., the Feige-Fiat-Shamir (FFS) identification scheme), the present disclosure creates unique, cryptographically secure identifiers (Merkle Roots) for each entity. In some aspects, an entity may be a customer (individual), or an organization, or other entity or grouping. The operations discussed herein enable rapid identification without exposing sensitive data, ensuring compliance with data privacy laws, without compromising system security. The system offers scalability to support growing customer counts and additional data points while maintaining high levels of security and privacy.

Various embodiments of the present disclosure leverage Merkle Trees and cryptography schemes (e.g., the FFS identification scheme) to create a new identification scheme to address the challenges of rapidly growing customer bases and stringent data privacy requirements. To do this, the system creates a unique, cryptographically secure identifier (Merkle Root) for each customer, incorporating various data points without exposing sensitive information. Various embodiments enable quick and accurate entity identification through the use of the Merkle Root as an “asset fingerprint” for the entity (e.g., the Merkle root is used to identify data associated with the given entity). The system provides enhanced data privacy by allowing authentication and verification without revealing actual customer data, thus complying with stringent privacy laws. Additionally, the system includes a scalable structure that can accommodate growing customer counts and additional data points without compromising efficiency or security. Encryption processes, such as the FFS scheme, are used to enable secure authentication, proving knowledge of customer secrets without exposing them. As such, various embodiments of the present disclosure provides for efficient management of large-scale customer identification while maintaining robust data privacy, addressing both the need for quick access to customer information and compliance with data protection regulations.

Example use cases include industries requiring secure and scalable identification, such as finance, healthcare, government, and e-commerce. The systems discussed herein may also be used by organizations that need to manage customer information securely, streamline identification processes, and comply with data privacy regulations.

The present disclosure offers a comprehensive solution for scalable, secure, and privacy-preserving identification in a digital ecosystem. By combining Merkle Tree structures with the Feige-Fiat-Shamir protocol, the system provides a robust framework for efficient customer and organization identification, balancing the need for rapid access with stringent privacy protections.

In various embodiments, an example method for identifying entities associated with encrypted values is provided to cure the deficiencies in traditional data management. The example method includes receiving at least one first entity identifier data packet associated with a first entity, wherein the at least one first entity identifier data packet includes a plurality of first entity identification values; generating a first entity Merkle root based on each of the plurality of first entity identification values; generating a first entity encryption associated with the first entity, wherein the first entity Merkle root is used as a public identifier for the first entity encryption; and determining the first entity associated with the first entity encryption based on the public identifier.

In various embodiments, systems and/or computer program products may be provided configured to carry out the operations of the method discussed herein.

### II. With Reference to the FIGS.

Reference will now be made in detail to aspects of the disclosure, examples of which are illustrated in the accompanying drawings. The following description refers to the accompanying drawings in which the same numbers in different drawings represent the same or similar elements unless otherwise represented. The implementations set forth in the following description do not represent all implementations consistent with the disclosure. Instead, they are merely examples of apparatuses and methods consistent with aspects related to the disclosure as recited in the appended claims. Particular aspects of the present disclosure are described in greater detail below. The terms and definitions provided herein control among any conflicts by incorporation by reference.

Systems, methods, and apparatuses are described herein that relate generally to securely managing and processing segmented data. In the following description, for purposes of explanation, numerous specific details are set forth to provide a thorough understanding of the present disclosure. It will be evident, however, to one skilled in the art that the present disclosure may be practiced without these specific details and/or with any combination of these details.

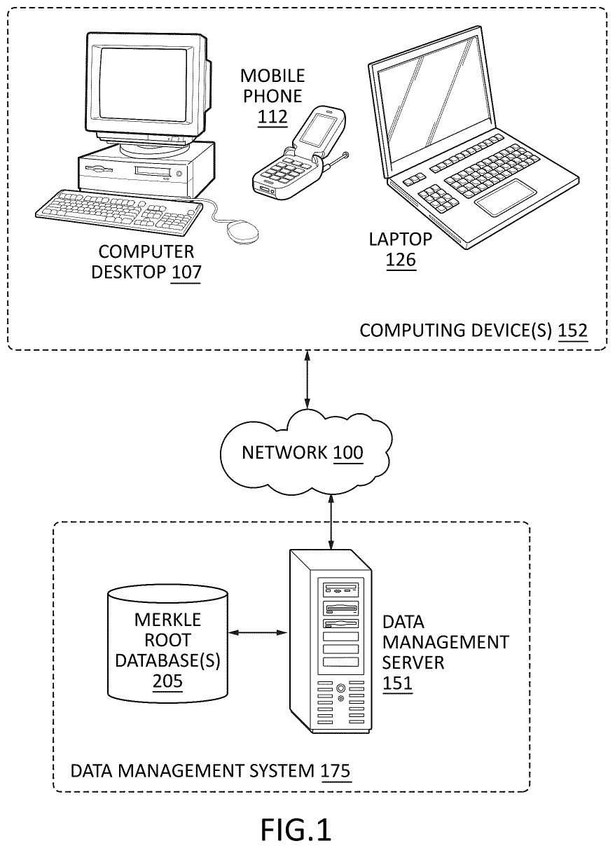

Referring now to FIG. 1, a block diagram illustrating a system environment (“system”) for securely managing and processing segmented data, in accordance with various embodiments is provided. The system includes computing device(s) 152 and a data management system 175 connected to a network 100. As shown, the computing device(s) 152 (e.g., desktop computer 107, mobile phone 112, laptop 126, and/or the like) associated with accounts are in communication with network 100. Computing device(s) 152 may be associated with users (e.g., associated with various entities and/or an administrator).

The data management system 175 is also in communication with the network 100. The data management system 175 includes one or more data management servers 151 and one or more Merkle root databases 205. In various embodiments, the data management server(s) 151 may be made of multiple servers. In various embodiments, the Merkle root database(s) 205 may be part of the data management server(s) 151 (e.g., at least a portion of the Merkle root database(s) 205 may be stored on the memory device(s) 268 of the data management server(s) 151). Additionally or alternatively, at least a portion of the Merkle root database(s) 205 may be stored remote from the data management server(s) 151. The Merkle root database(s) 205 may be part of, or in communication with the data management system 175. The Merkle root database(s) 205 may include entity data for one or more entities. The Merkle root database(s) 205 may include the entity data across multiple entities. The Merkle root database(s) 205 may include entity data that is encrypted and/or Merkle tree information associated for one or more entities. For example, the Merkle root database(s) 205 may include the Merkle root for one or more entities to be used as discussed herein to identify entity data without having to decrypt and/or otherwise access the entity data. The entity data may be stored with the Merkle tree information and/or the entity data may be stored remotely from the Merkle tree information.

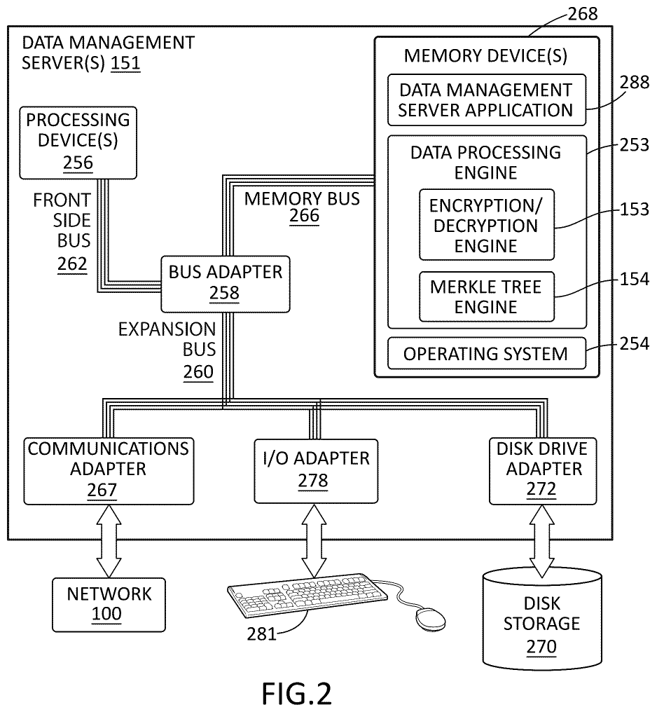

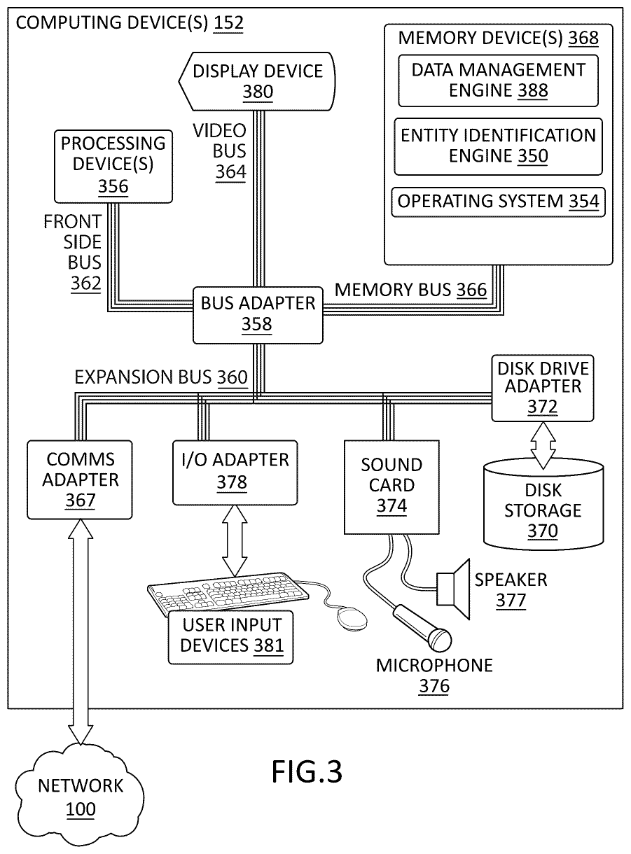

Referring now to FIG. 2, a block diagram illustrating the data management server(s) 151 of FIG. 1 in accordance with various embodiments is provided. FIG. 2 is merely illustrative of an example data management server(s) 151. In various embodiments, the data management server(s) 151 may share components with the computing device(s) 152 (e.g., the data management server(s) 151 may use at least a portion of the processing device(s) 356 of the computing device(s) 152 shown in FIG. 3). The data management server(s) 151 may be comprised of one or more servers. In various embodiments, the data management server(s) 151 may be capable of processing user inputs via a computing device(s) 152 and generating user interfaces to be rendered to the computing device(s) 152.

The data management server(s) 151 of FIG. 2 includes one or more processing devices 256 and one or more memory devices 268, communication adapter 267, an input/output adapter 278, and a disk drive adapter 272. In various embodiments, the various components may be connected to one another via a BUS adapter 258 (e.g., the processing device(s) 256 may be attached via a front-side BUS 262, the memory device(s) 268 may be attached via a memory BUS 266, and the communication adapter 267, I/O adapter 278, disk drive adapter 272, and/or other interfaces may be attached via an expansion BUS 260).

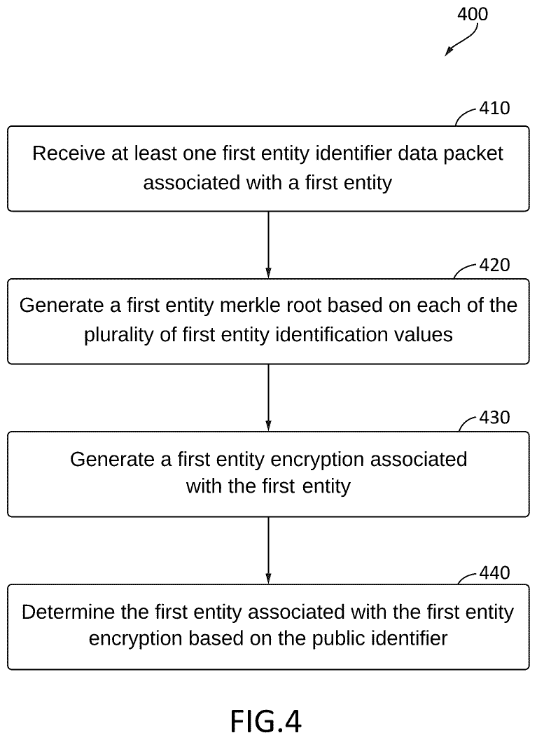

It should be understood that the memory device(s) 268 may include one or more databases or other data structures/repositories. The memory device(s) 268 also includes computer-executable program code that instructs the processing device(s) 256 to operate the network communication interface (e.g., communication adapter 267) to perform certain communication functions of the system described herein. For example, in one embodiment of the data management server(s) 151, the memory device(s) 268 includes, but is not limited to, a data management server application 288, a data processing engine 253, and an operating system 254. The data processing engine 253 may also include an encryption/decryption engine 153, a Merkle tree engine 154, and/or the like with instructions to carry out the processing of the entity data. The encryption/decryption engine 153 may include instructions for encrypting and/or decrypting data, such as entity data. The entity data may be encrypted as discussed in reference to FIG. 4 (e.g., using the Merkle root for an entity as the public identifier). The Merkle tree engine 154 may include instructions for generating the Merkle tree and/or the Merkle root for a given entity. The data processing engine 253 may also include instructions for identifying entities associated with encrypted data, as discussed herein.

Some embodiments of the data management server(s) 151 include processing device(s) 256 communicably coupled to such components as the memory device(s) 268, the communication adapter 267, the input/output adapter 278, the disk drive adapter 272, and/or the like. The processing device(s) 256, and other processors described herein, generally include circuitry for implementing communication and/or logic functions of the system. For example, the processing device(s) 256 may include a digital signal processor device, a microprocessor device, and various analog-to-digital converters, digital-to-analog converters, and/or other support circuits. Control and signal processing functions of the data management server(s) 151 are allocated between these devices according to their respective capabilities. The processing device(s) 256 thus may also include the functionality to encode and interleave messages and data prior to modulation and transmission. The processing device(s) 256 can additionally include an internal data modem. Further, the processing device(s) 256 may include functionality to operate one or more software programs, which may be stored in the memory device(s) 268. For example, the processing device(s) 256 may be capable of operating a connectivity program to communicate via the communication adapter 267.

The processing device(s) 256 is configured to connect to the network 100 via the communication adapter 267 to communicate with one or more other devices on the network 100. In this regard, the communication adapter 267 may include various components, such as an antenna operatively coupled to a transmitter and a receiver (together a “transceiver”). The processing device(s) 256 is configured to provide signals to and receive signals from the transmitter and receiver, respectively. The signals may include signaling information in accordance with the air interface standard of the applicable cellular system of the network 100. In this regard, the data management server(s) 151 may be configured to operate with one or more air interface standards, communication protocols, modulation types, and access types. By way of illustration, the data management server(s) 151 may be configured to operate in accordance with any of a number of first, second, third, fourth, and/or fifth-generation communication protocols and/or the like. In various embodiments, the data management server(s) 151 may also be connected via other connection methods to one or more components of the data management system 175.

The I/O adapter 278, which allow the data management server(s) 151 to receive data from a user such as a system administrator, may include any of a number of devices allowing the data management server(s) 151 to receive data from the user, such as a keypad, keyboard 281, touch-screen, touchpad, microphone, mouse, joystick, other pointer device, button, soft key, and/or other input device(s). The user interface may also include a camera, such as a digital camera.

The disk drive adapter 272 may provide additional storage space via disk storage 270. Various other storage mediums may also be used by the data management server(s) 151, such as cloud storage (e.g., transmitted via the communication adapter 267).

Referring now to FIG. 3, a block diagram illustrating the computing device(s) 152 of FIG. 1, in accordance with various embodiments is provided. FIG. 3 is merely illustrative of an example computing device(s) 152. Various types of computing device(s) 152 may be used or otherwise contemplated for the system. The computing device(s) 152 may be any computing device that is used to process the entity data as discussed herein (e.g., the flowchart 400 of FIG. 4).

Example computing devices include desktop computers 107, mobile devices, such as mobile phones 112, tablets, smart watches, etc., laptops 126, and/or the like. As such, the computing device(s) 152 may be any device that is capable of performing the operations discussed herein. For example, a mobile phone may include communication interfaces to communicate with mobile networks and local area networks (e.g., via Wi-Fi).

The computing device(s) 152 of FIG. 3 includes one or more processing devices 356, one or more memory devices 368, a display device 380, a communication adapter 367, an input/output adapter 378, and a disk drive adapter 372. In various embodiments, the various components may be connected to one another via a BUS adapter 358 (e.g., the processing device(s) 356 may be attached via a front side BUS 362, the memory device(s) 368 may be attached via a memory BUS 366, the display device 380 may be attached via a video BUS 364, and the communication adapter 367, I/O adapter 378, disk drive adapter 372, and/or other interfaces may be attached via expansion BUS 360).

It should be understood that the memory device(s) 368 may include one or more databases or other data structures/repositories. The memory device(s) 368 also includes computer-executable program code that instructs the processing device(s) 356 to operate the network communication interface (e.g., communication adapter 367) to perform certain communication functions of the system described herein. The memory device(s) 368 may include a data management engine 388 with instructions on receiving data and/or processing data as discussed herein. The memory device(s) 368 also includes an entity identification engine 350 that includes instructions on determining entities associated with given entity data as discussed herein. The memory device(s) 368 may also include the operating system 354 of the computing device(s) 152, which may determine the folder and/or file formatting.

Some embodiments of the computing device(s) 152 include processing device(s) 356 communicably coupled to such components as the memory device(s) 368, the communication adapter 367, the input/output adapter 378, the disk drive adapter 372, and/or the like. The processing device(s) 356, and other processors described herein, generally include circuitry for implementing communication and/or logic functions of the system. For example, the processing device(s) 356 may include a digital signal processor device, a microprocessor device, and various analog to digital converters, digital to analog converters, and/or other support circuits. Control and signal processing functions of the computing device(s) 152 are allocated between these devices according to their respective capabilities. The processing device(s) 356 thus may also include the functionality to encode and interleave messages and data prior to modulation and transmission. The processing device(s) 356 can additionally include an internal data modem. Further, the processing device(s) 356 may include functionality to operate one or more software programs, which may be stored in the memory device(s) 368. For example, the processing device(s) 356 may be capable of operating a connectivity program to communicate via the communication adapter 367.

The processing device(s) 356 is configured to connect to the network 100 via the communication adapter 367 to communicate with one or more other devices on the network 100. In this regard, the communication adapter 367 may include various components, such as an antenna operatively coupled to a transmitter and a receiver (together a “transceiver”). The processing device(s) 356 is configured to provide signals to and receive signals from the transmitter and receiver, respectively. The signals may include signaling information in accordance with the air interface standard of the applicable cellular system of the network 100. In this regard, the computing device(s) 152 may be configured to operate with one or more air interface standards, communication protocols, modulation types, and access types. By way of illustration, the computing device(s) 152 may be configured to operate in accordance with any of a number of first, second, third, fourth, and/or fifth-generation communication protocols and/or the like.

The I/O adapter 378, which allows the computing device(s) 152 to receive data from a user such as a system administrator, may include any of a number of devices allowing the computing device(s) 152 to receive data from the user, such as a keypad, keyboard 381, touch-screen, touchpad, microphone, mouse, joystick, other pointer device, button, soft key, and/or other input device(s). The user interface may also include a camera, such as a digital camera.

The disk drive adapter 372 may provide additional storage space via disk storage 370. Various other storage mediums may also be used by the computing device(s) 152, such as cloud storage (e.g., transmitted via the communication adapter 367).

As described above, the computing device(s) 152 has/have a user interface that is, like other user interfaces described herein, rendered via the display device 380. The display device 380 includes a display (e.g., a liquid crystal display, LED, OLED, or the like) and/or a speaker or other audio device, which are operatively coupled to the processing device(s) 356. As such, the folder(s) and/or file(s) discussed herein may be provided to the computing device(s) 152 via the display device 380 (e.g., visually via the user interface). In various embodiments, the display device 380 may be in communication with a sound card 374 (e.g., attached to a microphone 376 and/or a speaker 377 (e.g., the speaker 377 may be part of the display device 380 or standalone)).

Referring now to FIG. 4, a flowchart 400 is provided for managing and processing segmented data in accordance with various embodiments. In various embodiments, the method of FIG. 4 may be carried out using processing device(s), such as processing device(s) within the data management system 175 and/or the one or more computing device(s) 152. As such, the operations herein may be carried out by any of the embodiments herein unless otherwise stated. Unless otherwise stated, the operations of FIG. 4 may be carried out by the same system, such as the systems of various embodiments discussed herein.

While the various embodiments herein may refer to the operations relating to a first entity, the operations may be carried out for any number of entities (e.g., a first entity, a second entity, a third entity, etc.). As such, the operations of FIG. 4 may be individually repeated for multiple entities (e.g., a distinct Merkle tree may be produced for each entity and the given Merkle root for the given entity may be used as the public identifier for the data associated with the given entity). As such, the various components (e.g., entity identifier data packet, entity identification values, etc.) may refer to the entity associated with the given component (e.g., a first entity identifier data packet may be associated with the first entity).

Referring now to Block 410 of FIG. 4, the method includes receiving at least one entity identifier data packet (e.g. at least one first entity identifier data packet) associated with a given entity (e.g. a first entity). The at least one first entity identifier data packet comprises a plurality of first entity identification values. The first entity identification values correspond to information associate with the first entity. For example, the plurality of first entity identification values may include an entity name, an entity address, an entity domain, an entity phone number, a provisioned product, a contact name, and/or the like. The first entity identification values may be known or otherwise public (e.g., public data related to the first entity may be used). For example, public data related to the first entity may be accessed via the internet and/or other public data sources. Additionally or alternatively, the first entity identification value(s) may be provided by the first entity. For example, a first entity may provide an entity name, an entity address, an entity domain, an entity phone number, and/or the like. The entity identifier, otherwise known here as the first entity identification may be any asset, including product identifiers, contact names, customer names, or any other field that may be used to identify an asset.

Referring now to Block 420 of FIG. 4, the method includes generating a first entity Merkle root based on each of the plurality of first entity identification values. A Merkle root may be produced using a Merkle tree. A Merkle tree is a cryptographic data structure used in computer science to efficiently organize and verify large datasets. Merkle trees enable quick verification that data hasn't been altered or tampered with, without the need to store or process the entire dataset. As discussed herein, each entity (e.g., a first entity, a second entity, a third entity, etc.) may have a Merkle tree (and a resulting Merkle root). As such, the first entity may have a first entity Merkle root that is produced using the identification values associated with the first entity.

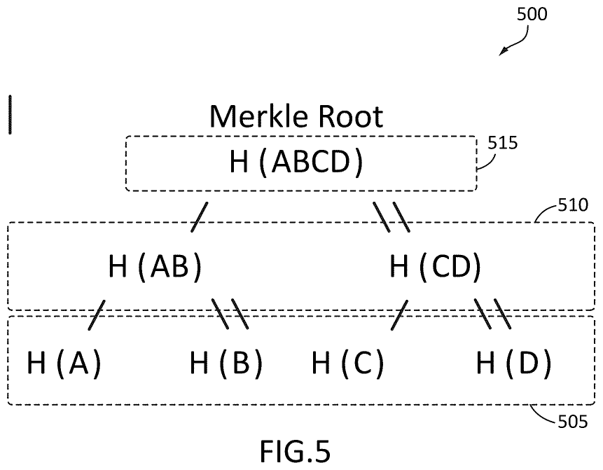

FIG. 5 illustrates an example Merkle tree 500. A Merkle tree used in various embodiments may be generated for one or more entities (e.g., each entity may have a distinct Merkle tree and subsequently a distinct Merkle root). A Merkle tree is a binary tree. A Merkle tree may have one or more leaf nodes 505 (e.g., bottom layer of a Merkle tree) that contains hashes of individual data blocks and/or transactions. For example, the individual data blocks (e.g., A, B, C, and D in FIG. 5) may be the entity identification values (e.g., an entity name, an entity address, an entity domain, or an entity phone number, and/or the like) for a given entity (e.g., a first entity). A Merkle tree may also have non-leaf nodes 510 (e.g., each node higher up in the Merkle tree that represents the hash of two children). For example, in FIG. 5, the non-leaf nodes may include a hash of AB and/or a hash of CD. The non-leaf nodes may be a hash of the non-hashed children nodes or a hash of the hashed children nodes (e.g., combination of hash(A) and hash(B)).

The root node 515, also referred to as a Merkle root may be the top of a Merkle tree and may be a hash that represents all of the data (e.g., all of the entity identification values) in the Merkle tree. For example, the Merkle root may be a hash of the top level of non-leaf nodes 510. As discussed herein, the Merkle root may be used as the identifier for the given entity throughout. As such, each entity (e.g., a first entity, a second entity, a third entity, etc.) may each have a Merkle tree produced using entity identification values for each given entity, and a Merkle root for the given entity may be used as an identifier for the given entity, as discussed herein.

In an example in which the Merkle tree has four inputs (e.g., four first entity identification values), the first entity Merkle root may be generated via a first hash of a first entity identification value and a second entity identification value of the plurality of first entity identification values and a second hash of a third entity identification value and a fourth entity identification value of the plurality of first entity identification values. In such an example, the first entity Merkle root may be generated via a hash using the first hash (e.g., the hash of the first entity identification value and the second entity identification value) and the second hash (e.g., the hash of the third entity identification value and the fourth entity identification value) as inputs. Additional or fewer inputs may be used to create the Merkle root as discussed below.

The example Merkle tree shown in FIG. 5 illustrates a Merkle root being creating with four inputs or nodes (e.g., four entity identification values). In an instance in which an odd number of nodes (e.g., identification values) are present, a node may be duplicated to make a complete pair (e.g., in an instance in which three inputs are provided, one of the inputs may be used twice to create an even number of nodes). As such, the Merkle root represents all of the inputs in the Merkle tree. As such, the Merkle root is the top of the Merkle tree regardless of the number of inputs. A Merkle tree may use any type of hash functionality, such as SHA-256 hash functionality.

Advantages of a Merkle tree include efficient verification (e.g., by checking the Merkle Root and a few intermediate hashes, the integrity of any individual data block may be verified without needing the entire dataset), tamper resistance (e.g., any change in any data block would alter the associated hash, which would propagate up the tree and change the Merkle Root, making tampering evident), efficient data transmission (e.g., only parts of the Merkle Tree need to be sent to verify a particular data block, making the Merkle tree useful in peer-to-peer networks and distributed ledgers), proof of inclusion (e.g., Merkle Trees allow “Merkle Proofs,” in which a subset of hashes can prove that a specific data block is part of the dataset), and/or the like.

As such, a Merkle Tree is a binary tree of hashes that provides a secure, efficient way to verify data integrity. By hashing data progressively up the tree to a single Merkle Root, the system creates a unique fingerprint of all the data associated with a given entity. The structure is essential in systems in which data integrity and efficient verification are needed, such as blockchains and distributed networks.

Referring now to Block 430 of FIG. 4, the method includes generating a first entity encryption associated with the first entity. The encryption may use any type of cryptographic scheme. For example, the encryption may use a Feige-Fiat-Shamir (FFS) identification scheme. The Merkle root for a given entity (e.g., the first entity Merkle root) may be used as the public identifier for an encryption associated with a given entity (e.g., the first entity encryption). The FFS scheme utilizes a zero-knowledge proof system, thus, the prover can prove its identity to the verifier without revealing sensitive information, staying privacy compliant.

Various embodiments of the present disclosure adapt the FFS protocol to use the Merkle Root as the public value (or “public identifier”). In an example use case, the parameters may be as follows. The public modulus (n) may be a large composite number generated by multiplying two large prime number (e.g., n=p X q, in which X denotes multiplication and p and q are two large prime numbers). The secret value(s) may be a secret value that is generated by a “prover.” In various embodiments, the secret value may be an entity PIN (e.g., a first entity PIN for the first entity) that is either user generated or randomly generated and provided to the prover. The public identifier, as discussed herein, is the Merkle root for the given entity. In various embodiments, a value v (v=s² mod n) may be linked to the Merkle Root, which will act as the primary identifier for authentication.

In various embodiments, the Merkle root may be converted and/or adjusted for use as a public identifier. For example, the Merkle root used may be converted from a hex format to a decimal format for use as the public identifier. In an instance in which the Merkle root is converted and/or adjusted, the type of conversion and/or adjustment may be known to allow for identification of the entity data.

In various embodiments, the encryption process may include a commitment step. The commitment step may include selection of a random commitment (r) by a prover that may be a random integer generated uniquely. The random commitment (r) may be used to generate an x that is sent to the verifier as the commitment value (x). For example, (x=r² mod n). The commitment value does not reveal anything related to the secret value(s). The commitment value may be sent to the verifier for the challenge step.

In various embodiments, the encryption process may include a challenge step. The challenge step may include the generation of a challenge bit e (e.g., e may be either zero or one). The challenge bit ensures that the prover response is not easily predicted or forged. For example, in an instance in which the e is zero, the prover may respond with y=r_{,} and in an instance in which the e is one, the prover may calculate y=r X s mod n, using secret value s. As such, the response y ensures that the prover has knowledge of the secret value s without revealing the secret value s.

In various embodiments, the encryption process may include a verification step. The verification step may include the verifier checking the validity of y. For example, in an instance in which e is zero, the verifier checks that y²=x mod n, and in an instance in which e is one, the verifier checks that y²=x×v mod n. In an instance in which the equation holds true, the verifier confirms that the prover knows the secret value s without actually having to know the secret value s.

Using the Merkle Root as a public identifier within the Feige-Fiat-Shamir scheme lets a user or system leverage the FFS protocol for secure authentication. The Merkle Root effectively serves as a proof of all underlying data, and by combining it with FFS, you can securely authenticate users without revealing personal identifying information (PII). In this schema, creating the unique universal classifier and identifier includes applying the Feige Fiat Shami identification scheme by first having a commitment step, wherein the prover selects a random commitment r, which is often a random integer. The prover calculates x=r² mod n and sends the commitment value x to the verifier. The verifier randomly generates a challenge bit e (0 or 1), and sends it back to the prover. The response step provides the prover calculating a response y based on the challenge e from the verifier. The verification step checks the validity of the y by performing a calculation of y²=x mod n. If the equation holds, the verifier is confident that the prover knows s, without needing the actual value.

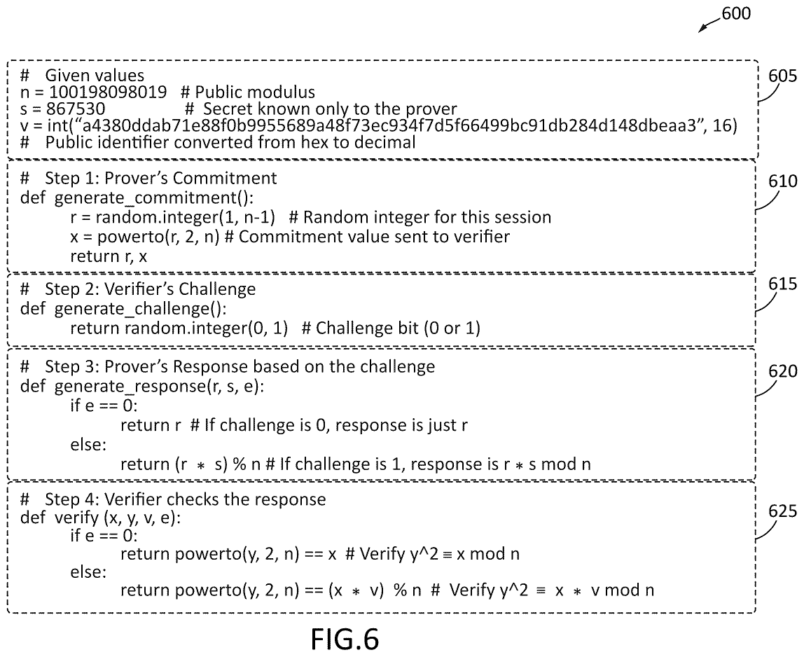

FIG. 6 illustrates an example code 600 used to perform the FFS scheme. As shown in block 605, the variables are assigned (e.g., public modulus n=100198098019, secret value s=867530, public identifier v=a4380ddab71e88f0b9955689a48f73ec934f7d5f66499bc91db284d148dbeaa3). As shown, the public identifier may be converted from hex format to decimal format during operations. The code 600 includes the commitment step 610, the verifier step 615, the prover response based on the challenge 620, and the verification step 625. Each of the steps corresponds to the operations discussed in reference to Block 430 of FIG. 4.

Referring now to Block 440 of FIG. 4, the method includes determining the first entity associated with the first entity encryption based on the public identifier. As discussed above in reference to Block 430, the public identifier being the Merkle root for the given entity (e.g., the first entity Merkle root) allows for entity data to be identified using the Merkle root without having to access and/or decrypt the underlying data.

As the public identifier is known, the system may identify the entity associated with given entity data. For example, the system may identify data associated with the public identifier (e.g., the Merkle root for a given entity may be used to search through one or more sets of entity data to identify the entity data associated with the given entity). Additionally or alternatively, the public identifier may be used to identify a specific set of entity data. For example, the public identifier for a set of entity data may be used to search for a corresponding Merkle root. As such, the system allows for a given set of entity data to be identified as related to an entity (e.g., the public identifier for a set of entity data may be used to identify the associated entity) and/or the system may be used to identify any entity data that is associated with a given entity (e.g., the Merkle root for a given entity may be used to identify entity data with the public identifier that matches the Merkle root).

In various embodiments, the first entity encryption is one of at least one encryptions. As such, the system may be able to determine a plurality of entities associated with one or more encryptions based on the public identifier for a given encryption. For example, each set of entity data may be associated with a given entity and the system may be used to identify the given entity associated with a given set of entity data based on the public identifier of the set of entity data and the Merkle root for the given entity.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### III. claim Clauses

Clause 1. A system for identifying entities associated with encrypted values, the system comprising: at least one non-transitory storage device; and at least one processing device coupled to the at least one non-transitory storage device, wherein the at least one processing device is configured to: receive at least one first entity identifier data packet associated with a first entity, wherein the at least one first entity identifier data packet comprises a plurality of first entity identification values; generate a first entity Merkle root based on each of the plurality of first entity identification values; generate a first entity encryption associated with the first entity, wherein the first entity Merkle root is used as a public identifier for the first entity encryption; and determine the first entity associated with the first entity encryption based on the public identifier.

Clause 2. The system of claim 1, wherein the first entity encryption uses a Feige-Fiat-Shamir (FFS) identification scheme.

Clause 3. The system of claim 1, wherein the at least one processing device is further configured to convert the first entity Merkle root from a hex to a decimal for use as the public identifier.

Clause 4. The system of claim 1, wherein the first entity Merkle root is generated via a first hash of a first entity identification value and a second entity identification value of the plurality of first entity identification values and a second hash of a third entity identification value and a fourth entity identification value of the plurality of first entity identification values.

Clause 5. The system of claim 4, wherein the first entity Merkle root is generated via a hash using the first hash and the second hash as inputs.

Clause 6. The system of claim 1, wherein the plurality of first entity identification values comprises at least one of an entity name, an entity address, an entity domain, or an entity phone number.

Clause 7. The system of claim 1, wherein the first entity Merkle root is generated using SHA-256 hash functionality.

Clause 8. The system of claim 1, wherein a first entity PIN is used as a secret value for the first entity encryption.

Clause 9. The system of claim 1, wherein the first entity associated with the first entity encryption is determined from the first entity encryption in an instance in which the first entity encryption is encrypted.

Clause 10. The system of claim 1, wherein the first entity encryption is one of at least one encryptions, wherein the at least one processing device is further configured to determine a plurality of entities associated with one or more encryptions based on the public identifier for a given encryption.

Clause 11. A method for identifying entities associated with encrypted values, the method comprising: receiving at least one first entity identifier data packet associated with a first entity, wherein the at least one first entity identifier data packet comprises a plurality of first entity identification values; generating a first entity Merkle root based on each of the plurality of first entity identification values; generating a first entity encryption associated with the first entity, wherein the first entity Merkle root is used as a public identifier for the first entity encryption; and determining the first entity associated with the first entity encryption based on the public identifier.

Clause 12. The method of claim 11, wherein the first entity encryption uses a Feige-Fiat-Shamir (FFS) identification scheme.

Clause 13. The method of claim 11, further comprising converting the first entity Merkle root from a hex to a decimal for use as the public identifier.

Clause 14. The method of claim 11, wherein the first entity Merkle root is generated via a first hash of a first entity identification value and a second entity identification value of the plurality of first entity identification values and a second hash of a third entity identification value and a fourth entity identification value of the plurality of first entity identification values.

Clause 15. The method of claim 14, wherein the first entity Merkle root is generated via a hash using the first hash and the second hash as inputs.

Clause 16. The method of claim 11, wherein the plurality of first entity identification values comprises at least one of an entity name, an entity address, an entity domain, or an entity phone number.

Clause 17. The method of claim 11, wherein the first entity Merkle root is generated using SHA-256 hash functionality.

Clause 18. The method of claim 11, wherein a first entity PIN is used as a secret value for the first entity encryption.

Clause 19. The method of claim 11, wherein the first entity associated with the first entity encryption is determined from the first entity encryption in an instance in which the first entity encryption is encrypted.

Clause 20. The method of claim 11, wherein the first entity encryption is one of at least one encryptions, wherein the method further comprises determining a plurality of entities associated with one or more encryptions based on the public identifier for a given encryption.

Clause 21. A computer program product for identifying entities associated with encrypted values, the computer program product comprising at least one non-transitory computer-readable medium having one or more computer-readable program code portions embodied therein, the one or more computer-readable program code portions comprising at least one executable portion configured to: receive at least one first entity identifier data packet associated with a first entity, wherein the at least one first entity identifier data packet comprises a plurality of first entity identification values; generate a first entity Merkle root based on each of the plurality of first entity identification values; generate a first entity encryption associated with the first entity, wherein the first entity Merkle root is used as a public identifier for the first entity encryption; and determine the first entity associated with the first entity encryption based on the public identifier.

Clause 22. The computer program product of claim 21, wherein the first entity encryption uses a Feige-Fiat-Shamir (FFS) identification scheme.

Clause 23. The computer program product of claim 21, wherein the one or more computer-readable program code portions comprise at least one executable portion further configured to convert the first entity Merkle root from a hex to a decimal for use as the public identifier.

Clause 24. The computer program product of claim 21, wherein the first entity Merkle root is generated via a first hash of a first entity identification value and a second entity identification value of the plurality of first entity identification values and a second hash of a third entity identification value and a fourth entity identification value of the plurality of first entity identification values.

Clause 25. The computer program product of claim 24, wherein the first entity Merkle root is generated via a hash using the first hash and the second hash as inputs.

Clause 26. The computer program product of claim 21, wherein the plurality of first entity identification values comprises at least one of an entity name, an entity address, an entity domain, or an entity phone number.

Clause 27. The computer program product of claim 21, wherein the first entity Merkle root is generated using SHA-256 hash functionality.

Clause 28. The computer program product of claim 21, wherein a first entity PIN is used as a secret value for the first entity encryption.

Clause 29. The computer program product of claim 21, wherein the first entity associated with the first entity encryption is determined from the first entity encryption in an instance in which the first entity encryption is encrypted.

Clause 30. The computer program product of claim 21, wherein the first entity encryption is one of at least one encryptions, wherein the one or more computer-readable program code portions comprise at least one executable portion further configured to determine a plurality of entities associated with one or more encryptions based on the public identifier for a given encryption.

1. A system for identifying entities associated with encrypted values, the system comprising:
at least one non-transitory storage device; and
at least one processing device coupled to the at least one non-transitory storage device, wherein the at least one processing device is configured to:
receive at least one first entity identifier data packet associated with a first entity, wherein the at least one first entity identifier data packet comprises a plurality of first entity identification values;
generate a first entity Merkle root based on each of the plurality of first entity identification values;
generate a first entity encryption associated with the first entity, wherein the first entity Merkle root is used as a public identifier for the first entity encryption; and
determine the first entity associated with the first entity encryption based on the public identifier.

2. The system of claim 1, wherein the first entity encryption uses a Feige-Fiat-Shamir (FFS) identification scheme.

3. The system of claim 1, wherein the at least one processing device is further configured to convert the first entity Merkle root from a hex to a decimal for use as the public identifier.

4. The system of claim 1, wherein the first entity Merkle root is generated via a first hash of a first entity identification value and a second entity identification value of the plurality of first entity identification values and a second hash of a third entity identification value and a fourth entity identification value of the plurality of first entity identification values.

5. The system of claim 4, wherein the first entity Merkle root is generated via a hash using the first hash and the second hash as inputs.

6. The system of claim 1, wherein the plurality of first entity identification values comprises at least one of an entity name, an entity address, an entity domain, an entity phone number, a provisioned product, or a contact name.

7. The system of claim 1, wherein the first entity Merkle root is generated using SHA-256 hash functionality.

8. The system of claim 1, wherein a first entity PIN is used as a secret value for the first entity encryption.

9. The system of claim 1, wherein the first entity associated with the first entity encryption is determined from the first entity encryption in an instance in which the first entity encryption is encrypted.

10. The system of claim 1, wherein the first entity encryption is one of at least one encryptions, wherein the at least one processing device is further configured to determine a plurality of entities associated with one or more encryptions based on the public identifier for a given encryption.

11. A method for identifying entities associated with encrypted values, the method comprising:
receiving at least one first entity identifier data packet associated with a first entity, wherein the at least one first entity identifier data packet comprises a plurality of first entity identification values;
generating a first entity Merkle root based on each of the plurality of first entity identification values;
generating a first entity encryption associated with the first entity, wherein the first entity Merkle root is used as a public identifier for the first entity encryption; and
determining the first entity associated with the first entity encryption based on the public identifier.

12. The method of claim 11, wherein the first entity encryption uses a Feige-Fiat-Shamir (FFS) identification scheme.

13. The method of claim 11, further comprising converting the first entity Merkle root from a hex to a decimal for use as the public identifier.

14. The method of claim 11, wherein the first entity Merkle root is generated via a first hash of a first entity identification value and a second entity identification value of the plurality of first entity identification values and a second hash of a third entity identification value and a fourth entity identification value of the plurality of first entity identification values.

15. The method of claim 14, wherein the first entity Merkle root is generated via a hash using the first hash and the second hash as inputs.

16. A computer program product for identifying entities associated with encrypted values, the computer program product comprising at least one non-transitory computer-readable medium having one or more computer-readable program code portions embodied therein, the one or more computer-readable program code portions comprising at least one executable portion configured to:
receive at least one first entity identifier data packet associated with a first entity, wherein the at least one first entity identifier data packet comprises a plurality of first entity identification values;
generate a first entity Merkle root based on each of the plurality of first entity identification values;
generate a first entity encryption associated with the first entity, wherein the first entity Merkle root is used as a public identifier for the first entity encryption; and
determine the first entity associated with the first entity encryption based on the public identifier.

17. The computer program product of claim 16, wherein the first entity encryption uses a Feige-Fiat-Shamir (FFS) identification scheme.

18. The computer program product of claim 16, wherein the one or more computer-readable program code portions comprise at least one executable portion further configured to convert the first entity Merkle root from a hex to a decimal for use as the public identifier.

19. The computer program product of claim 16, wherein the first entity Merkle root is generated via a first hash of a first entity identification value and a second entity identification value of the plurality of first entity identification values and a second hash of a third entity identification value and a fourth entity identification value of the plurality of first entity identification values.

20. The computer program product of claim 19, wherein the first entity Merkle root is generated via a hash using the first hash and the second hash as inputs.
